(19) United States
(12) Patent Application Publication
(10) Pub. No.: US 2013/0159777 A1
(43) Pub. Date: Jun. 20, 2013

(54) TESTING SYSTEM AND METHOD FOR TESTING ELECTRONIC DEVICE

(71) Applicant: KANG-BIN WANG, Shenzhen City (CN)

(72) Inventor: KANG-BIN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/564,793

(22) Filed: Aug. 2, 2012

(30) Foreign Application Priority Data
Dec. 16, 2011 (CN) 201110423303.0

(51) Int. Cl. G06F 11/28

(52) U.S. Cl. 714/37; 714/E11.178

(57) ABSTRACT

A testing system for testing an under test electronic device, includes an error capturing and latching unit, a storage unit, and a control terminal. The error capturing and latching unit detects and captures running error signals of the under test electronic device. The storage unit stores the running error signals. The control terminal is connected to the storage unit. The control terminal picks out the running error signals from the storage unit and analyzes these signals.

### BACKGROUND

1. Technical Field

The present disclosure relates to testing systems and methods, and more particularly to a testing system and method for testing electronic devices.

2. Description of Related Art

After an electronic device is developed, an overall test is required to check the electronic device. The test mainly aims at the requirements of resistance of elevated temperature, stableness of power supply, and stableness of running, for example. However, this testing method cannot capture detailed testing process. It is difficult to analyze and solve problems which are generated in the testing process.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a testing system for testing an under test electronic device in accordance with an embodiment.

FIG. 2 illustrates a flowchart of a testing method for testing an under test electronic device in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

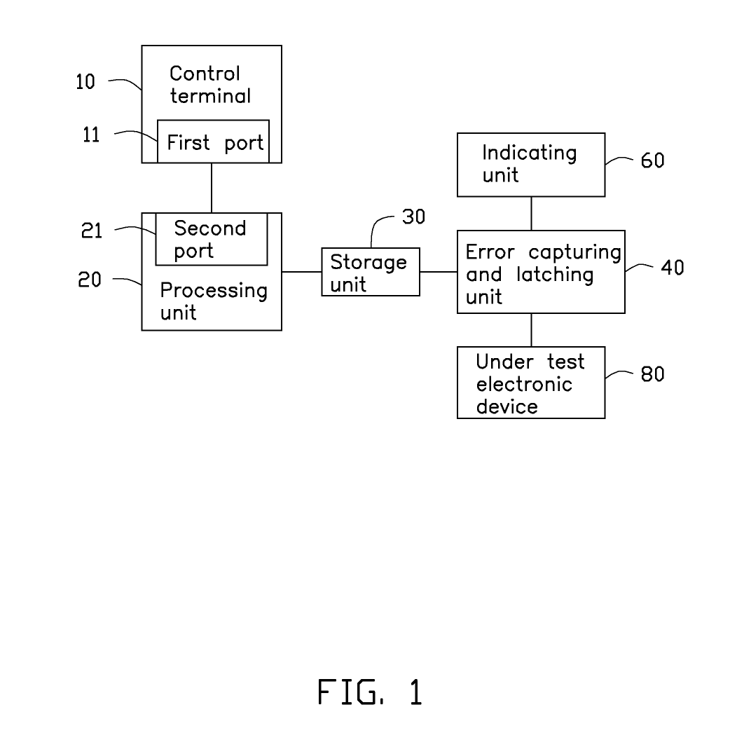

FIG. 1 shows an embodiment of a testing system for testing an under test electronic device 80. The testing system includes a control terminal 10, a processing unit 20, a storage unit 30, an error capturing and latching unit 40, and an indicating unit 60.

The control terminal 10 includes a first port 11. The processing unit 20 includes a second port 21. The first port 11 and the second port 21 are same type of ports, and can connect to each other to communicate between the control terminal 10 and the processing unit 20.

The storage unit 30 is connected to the processing unit 20. The error capturing and latching unit 40 is connected to the storage unit 30, the indicating unit 60 and the under test electronic device 80. The error capturing and latching unit 40 can detect and capture running error signals of the under test electronic device 80 when the under test electronic device 80 is running. The error capturing and latching unit 40 latches the running error signals therein and controls the indicating unit 60 to indicate in some manner, such as flashing light in red, and so on, to show the error capturing and latching unit 40 have latched the running error signals.

The error capturing and latching unit 40 can store the running error signals in the storage unit 30. The control terminal 10 can pick out the running error signals from the storage unit 30 via the processing unit 20, and analyzes these running error signals.

The control terminal 10 can transmit debugging signals to the processing unit 20. The processing unit 20 can send the debugging signals to the under test electronic device 80 to debug the under test electronic device 80. The control terminal 10 can set a sampling frequency for the error capturing and latching unit 40. The error capturing and latching unit 40 detects the under test electronic device 80 under the sampling frequency.

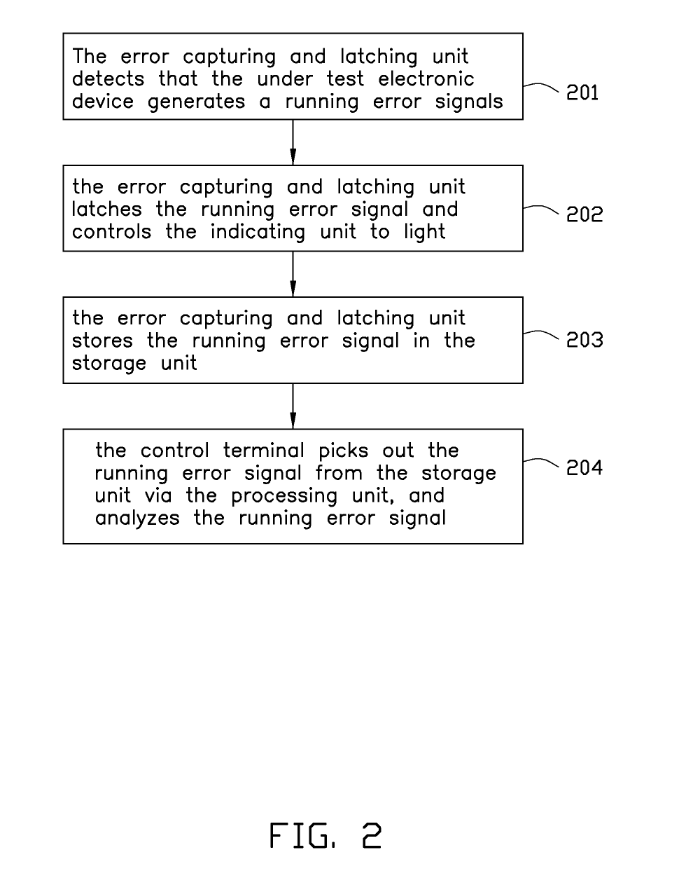

FIG. 2 shows an embodiment of a testing method for testing the under test electronic device 80. The testing method includes the following steps:

In step 201, the error capturing and latching unit 40 detects if the under test electronic device 80 generates any running error signals; if there is a running error signal, go to step 202.

In step 202, the error capturing and latching unit 40 latches the running error signal and controls the indicating unit 60 to flash light.

In step 203, the error capturing and latching unit 40 stores the running error signal in the storage unit 30.

In step 204, the control terminal 10 picks out the running error signal from the storage unit 30 via the processing unit 20, and analyzes the running error signal.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A testing system for testing an under test electronic device, comprising:
an error capturing and latching unit connected to the under test electronic device, the error capturing and latching unit configured to detect and capture running error signals of the under test electronic device;
a storage unit connected to the error capturing and latching unit, the storage unit configured to store the running error signals; and
a control terminal connected to the storage unit, the control terminal configured to pick out the running error signals from the storage unit and analyze these signals.

2. The testing system of claim 1, wherein an indicating unit is connected to the error capturing and latching unit, and the indicating unit is configured to indicate that the error capturing and latching unit have detected and captured running error signals.

3. The testing system of claim 1, wherein a processing unit is connected between the control terminal and the storage unit, the control terminal comprises a first port, the processing unit comprises a second port, and the first port is connected to the second port to communicate the control terminal with the processing unit.

4. The testing system of claim 3, wherein the control terminal is configured to transmit testing signals to the processing unit, and the processing unit is configured to test the under test electronic device.

5. The testing system of claim 3, wherein the first port and the second port are same type ports.

6. The testing system of claim 1, wherein the control terminal is configured to set a sampling frequency for the error capturing and latching unit to detect the under test electronic device under the sampling frequency.

7. A testing method for testing an under test electronic device, comprising:
detecting and capturing running error signals of the under test electronic device by an error capturing and latching unit;
storing the running error signals in a storage unit; and
picking out the running error signals from the storage unit and analyzing these signals by a control terminal

8. The testing method of claim 7, wherein before storing the running error signals in the storage unit, the error capturing and latching unit latches the running error signals therein.

9. The testing method of claim 7, wherein the control terminal sets a sampling frequency for the error capturing and latching unit to detect the under test electronic device under the sampling frequency.

10. The testing method of claim 7, wherein a processing unit is connected between the control terminal and the storage unit, and the control terminal is connected to the storage unit via the processing unit.
